(19) United States
(12) Patent Application Publication
(10) Pub. No.: US 2024/0123893 A1
(43) Pub. Date: Apr. 18, 2024

(54) Mobile Gaming System

(71) Applicant: Gerard Burke, San Francisco, CA (US)

(72) Inventor: Gerard Burke, San Francisco, CA (US)

(21) Appl. No.: 17/966,482

(22) Filed: Oct. 14, 2022

(51) Int. Cl. B60P 3/025; B60D 1/66

(52) U.S. Cl. CPC B60P 3/025; B60D 1/66

(57) ABSTRACT

The present invention is a mobile gaming system that is moved on a roadway by a motor vehicle and towed to a location as desired and set up once positioned in a desired location.

### BACKGROUND OF THE INVENTION

For many years, persons that wanted mobile gaming systems were limited by those items that could be stored in the trunk of a car or easily transportable from one place to another. If someone had a need or desire for a significantly sized gaming table, there is no way that such a system could be easily transported. There is a need for mobile gaming system.

The present invention addresses this need.

### SUMMARY OF THE INVENTION

As generally understood, the present invention is a novel mobile game table system. In the demonstrated embodiment herein, there is a pool table on top and the system is easily transported. The system is movable and easily sets up anywhere, such as parks, football games, parties, camp sites, and home In one embodiment, the system includes any one or combination of: a music system, karaoke hookup, TV—and when the system table is open, it has a flip down TV, and configured for video games, movies, and live TV such as GameDay at a game.

The system is configured as light weight compared to current systems so it is easily towed with a small car or truck

In one embodiment, the system is configured with storage as it opens and closes exposing storage cavities. Such storage is suitable for camping equipment, work tools, and the like.

The system is constructed with significant strength and is also suitable to haul small boats, cycling equipment, bikes, motorcycle, ladders, cooler, dog kennel, and tools with the protector top cover.

The system includes a lighting system. The lighting system has lights and flashing lights for night time use. In one embodiment, the system further includes smoke/fog machine.

The system is configured with a receiver tow hitch on the trailer and, when removed, can be used for work vise, small baseball loop, or a arm wrestling table, BBQ grill or table for camping when stationary

The top of the system can be used as a gambling table, table tennis, air hockey, beer pong

The system can be used as a work bench in a garage or shop with the work bench to add on.

The system is configured and moves around 360 degrees for each movement with lock wheels.

The trailer wheels of the system are removable making the system equally suitable for indoor home use.

The trailer can be used as tool trailer with drawers add in the side instead of the speaker on sound system that slide in and out.

The inside the trailer can be made in to a big cooler insulated for meat, fish, poultry and the hunter person to keep meat fresh.

The system can be used as a gun store with the right lock on it so unauthorized person cannot get in to it.

The top cover can be removed and moved to the side and be used as a picnic table with fold down legs.

The system opens and closes with a 600 lb electric ram to access the interior.

In one embodiment, the invention is a system for mobile gaming, said system comprising:
a main body set on a pair of wheels suitable for road transport;
a hitch connected to one end of said main body;
a cavity configured within said main body, said cavity accessed from on top of said main body;
at least one cover for said cavity; and
a gaming table constructed and arranged to secure to an upper horizontal surface of said main body.

In one embodiment, the system further includes an extendable and retractable jack legs associated with said main body.

In one embodiment, the system further includes an extendable and retractable jack legs associated with said main body, wherein said jack legs are independently vertically adjustable.

In one embodiment, the system further includes a lighting system.

In one embodiment, the system further includes an audio system.

In one embodiment, the system further includes a lighting and audio system.

In one embodiment, the hitch further includes a connector, vise support and vise.

In one embodiment, the invention is a system for mobile gaming, said system consists of:
a main body set on a pair of wheels suitable for road transport;
a hitch connected to one end of said main body;
a cavity configured within said main body, said cavity accessed from on top of said main body;
at least one cover for said cavity; and
a gaming table constructed and arranged to secure to an upper horizontal surface of said main body, where the extendable and retractable jack legs are associated with said main body and are independently vertically adjustable; including a lighting and audio system; and a connector, vise support and vise.

### BRIEF DESCRIPTION OF THE SEVERAL VIEWS OF THE DRAWINGS

FIG. 1 is a side perspective view according to one embodiment of the present invention.

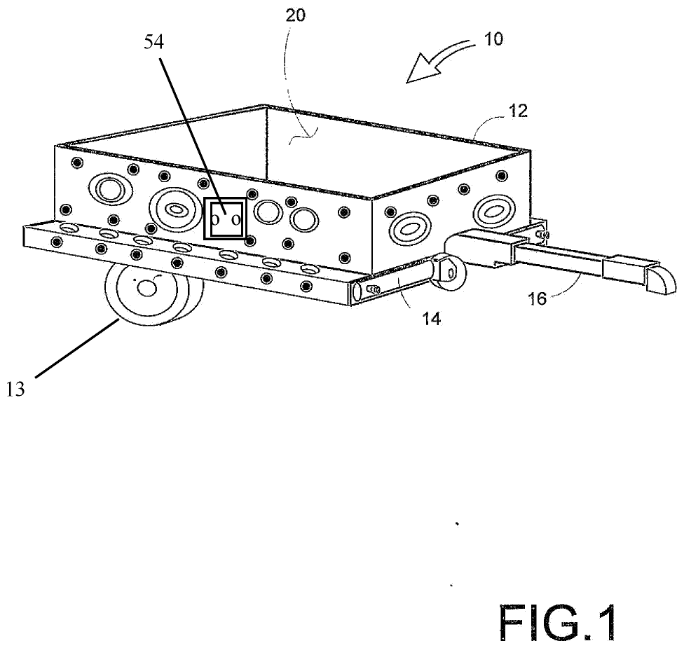

FIG. 2 is a side perspective you demonstrating placement of jack legs according to one embodiment of the present invention.

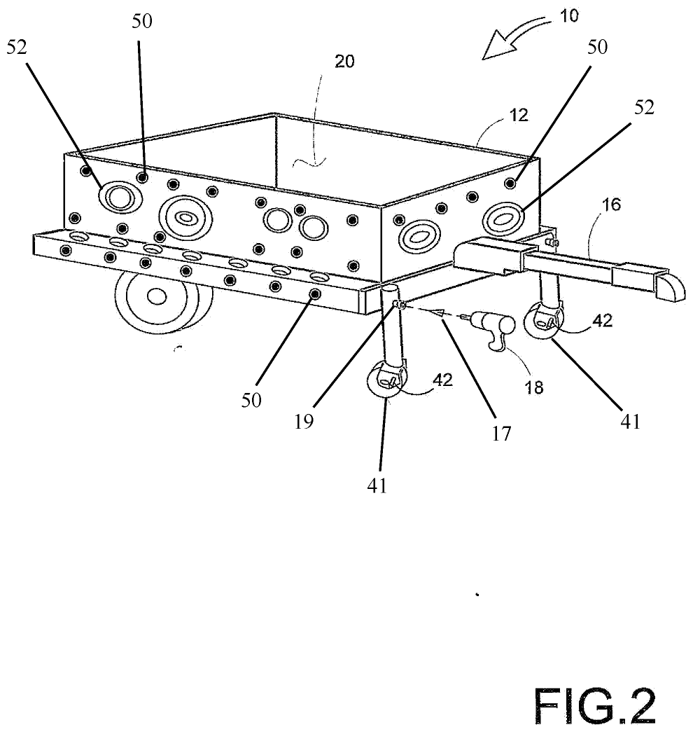

FIG. 3 is a view of the vise attachment according to one embodiment of the present invention.

FIG. 4 is a side perspective view demonstrating the interior storage cavity according to one embodiment of the present invention.

FIG. 5 is a side perspective view demonstrating the interior storage cavity according to one embodiment of the present invention.

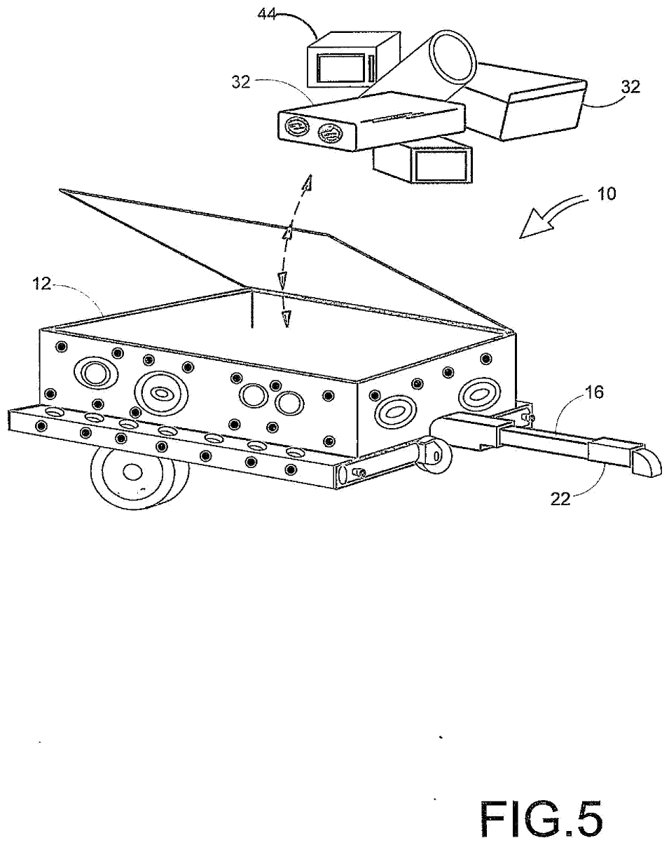

FIG. 6 demonstrates placement and positioning of various surfaces according to one embodiment of the present invention.

FIG. 7 demonstrates use of a protective cover according to one embodiment of the present invention.

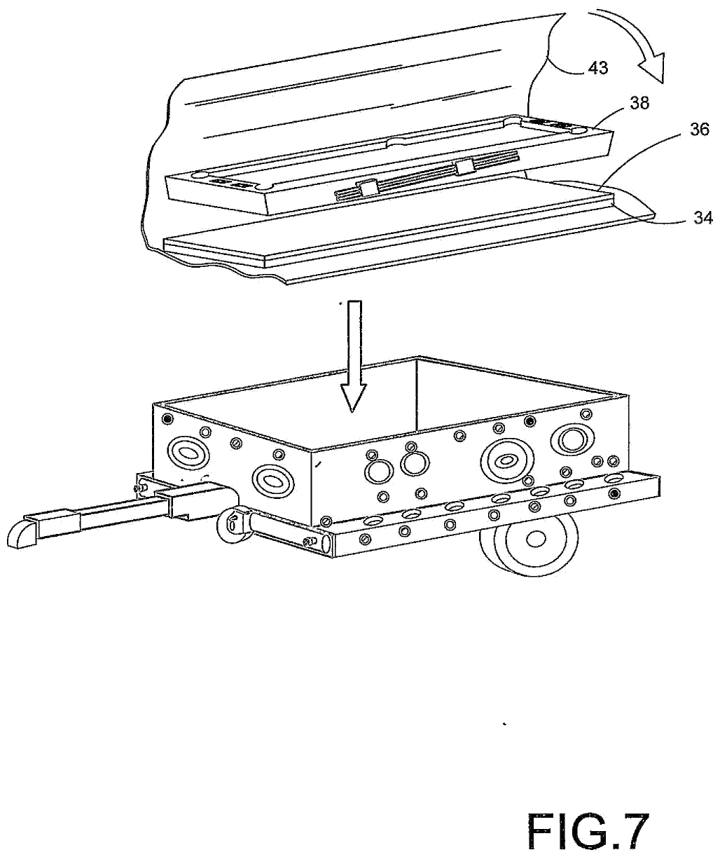

### DETAILED DESCRIPTION OF THE PREFERRED EMBODIMENTS

Although the drawings depict a particularized embodiment utilizing a hand reader, the present invention is contemplated as configurable in any physical structure whereby the inventive scope and concept are achieved.

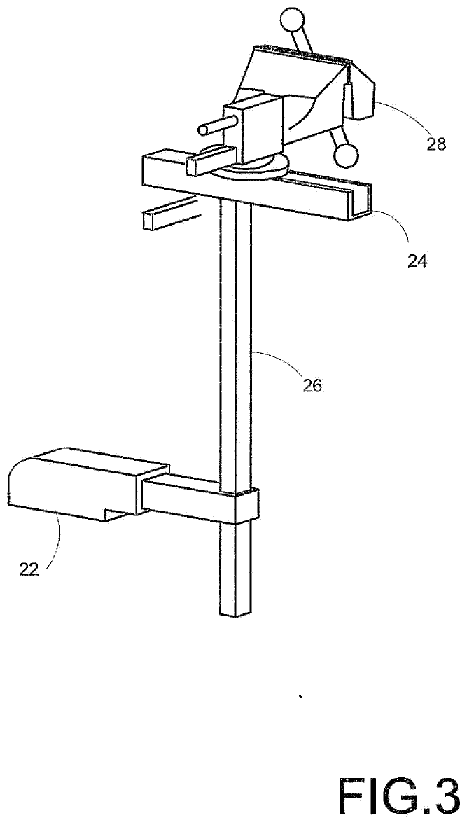

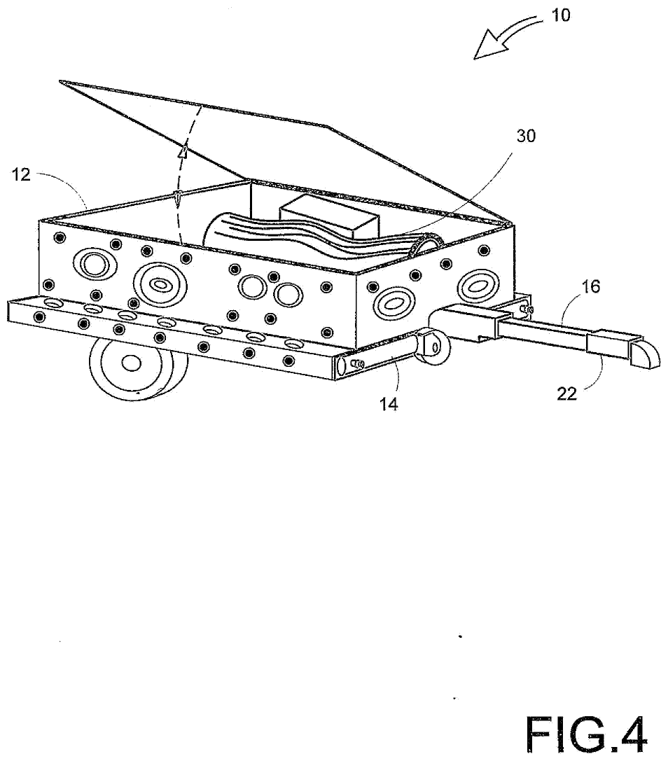

System 10 includes main body 12 constructed and arranged as a mobile and movable system utilizing wheels 13 and hitch 16. The system includes an interior storage cavity 20. A pair of movable jacklegs 14 pivotably extend and retract as desired. Each Jack leg 14 is constructed it arranged with a wheel 41 at its distal end that includes wheel lock pin 42 constructed arrange to secure system 10 into a fixed position. In one embodiment, vise 28 is secured onto mount channel 24 that is constructed and arranged such that vice support 26 interacts there with. Vise 28 is operatively associated with connector 22 and ultimately is connected to hitch 16. Although FIG. 3 demonstrates use of a vice system, it is contemplated that a plurality of accessories are configured and use with the system of the present invention. Accessories include, but are not limited to, various pieces of exercise equipment, cooking appliances and implements, additional lighting systems, combinations thereof, and similar accessories desirable with the mobile system of the present invention. In one embodiment, storage cavity 20 is constructed arranged to transport articles therein. For illustrative purposes only, camping gear 30 is positioned within storage cavity 20, as shown in FIG. 4.

Further, for demonstrative purposes only, sound and entertainment equipment 32, television 44 and other such desired articles are stored in storage cavity 20.

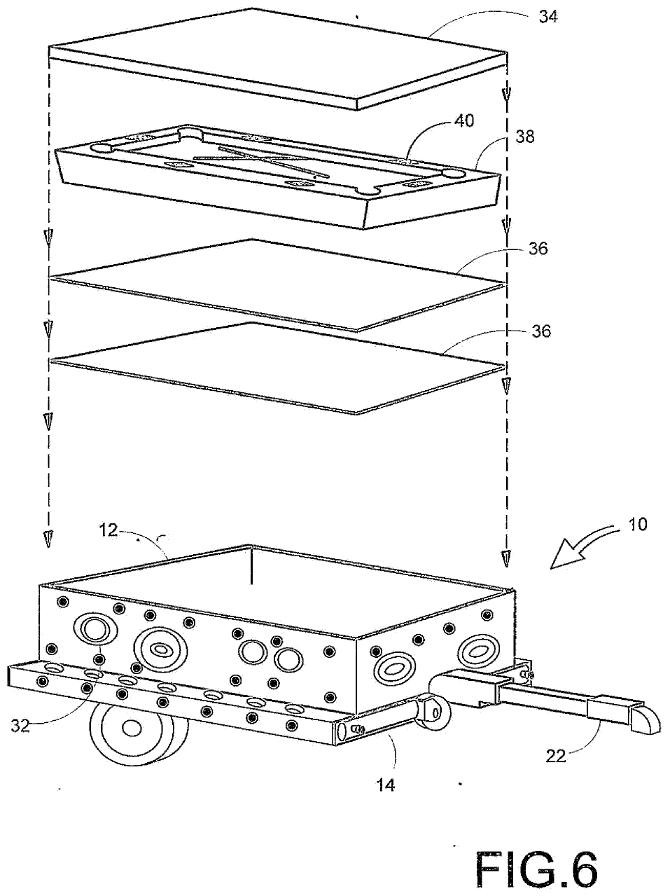

As demonstrated in FIG. 6, one or more covers are configured for use with the system of the present invention. This includes plywood cover 36 pool table 38 Styrofoam cover 34. Although the British revised embodiment demonstrated in the figure is for a pool table, the present invention contemplates any gaming type table configurable for use in the present invention. Pool table 38 includes one or more spirit levels 40 incorporated with the physical structure such that leveling as needed is easily accomplished. Leveling of pool table 40 is accomplished by adjusting jacklegs 14 as needed in order to import a level playing surface. In one environment, a protective cover 43 is utilized with the present invention whereby protective cover 43 is drawn over the entire ready of pool table 38 as desired.

The system contemplates a plurality of lights 50 and audio speakers 52. About the figure demonstrates a plurality of individual lights 50. The present invention contemplates use of any one or combination of individualized lights, light bars, light tubes, and other appropriate electronic illumination devices.

In use, a user will transport system 10 utilizing hitch 16 in which the unit will be rolled to a desire location on wheels 13. Once in location, if desired, a user will extend truck legs 14 and secure them into position using securing pin 17 into securing pin receiver 19 and an appropriate device such as hand drill 18.

A user will remove any covers that are affixed to system 10. Pool table 38 is positioned on top of system 10 and leveled according to spirit levels 40 as needed.

Light and audio controls are accessed using control panel 54 that is configured in order to selectively control lighting and audio settings of system 10.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A system for mobile gaming, said system comprising:
a main body set on a pair of wheels suitable for road transport;
a hitch connected to one end of said main body;
a cavity configured within said main body, said cavity accessed from on top of said main body;
at least one cover for said cavity; and
a gaming table constructed and arranged to secure to an upper horizontal surface of said main body.

2. The system of claim 1 further including extendable and retractable jack legs associated with said main body.

3. The system of claim 1 further including extendable and retractable jack legs associated with said main body, wherein said jack legs are independently vertically adjustable.

4. The system of claim 1 wherein said system further includes a lighting system.

5. The system of claim 1 wherein said system further includes an audio system.

6. The system of claim 1 wherein said system further includes a lighting and audio system.

7. The system of claim 1 wherein said hitch further includes a connector, vise support and vise.
